(19) United States
(12) Patent Application Publication
(10) Pub. No.: US 2024/0419599 A1
(43) Pub. Date: Dec. 19, 2024

(54) DIRECT CACHE TRANSFER WITH SHARED CACHE LINES

(71) Applicant: Akeana, Inc., San Jose, CA (US)

(72) Inventor: Madhavi Kondapaneni, Cupertino, CA (US)

(73) Assignee: Akeana, Inc., San Jose, CA (US)

(21) Appl. No.: 18/743,194

(22) Filed: Jun. 14, 2024

Related U.S. Application Data
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/653,402, filed on May 30, 2024.

(51) Int. Cl. G06F 12/084

(52) U.S. Cl. CPC G06F 12/084; G06F 2212/622

(57) ABSTRACT

Disclosed embodiments provide techniques for direct cache transfer with shared cache. A system on a chip (SOC) is accessed. The SOC includes a plurality of coherent request nodes and a home node. The home node includes a directory-based snoop filter (DSF). A request node requests ownership of a coherent cache line within the SOC. The requesting includes an address associated with the coherent cache line. The home node detects that the coherent cache line is shared with one or more other request nodes. The home node determines a current owner of the coherent cache line. The home node sends an invalidating snoop instruction to the one or more other request nodes and transmits a forwarding snoop instruction. The forwarding snoop instruction establishes a direct cache transfer between the request node and the current owner of the coherent cache line.

### RELATED APPLICATIONS

This application claims the benefit of U.S. provisional patent applications “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563,102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, and “Direct Data Transfer With Cache Line Owner Assignment” Ser. No. 63/653,402, filed May 30, 2024.

Each of the foregoing applications is hereby incorporated by reference in its entirety.

### FIELD OF ART

This application relates generally to computer processors and more particularly to direct cache transfer with shared cache lines.

### BACKGROUND

Computer processors play a pivotal role in modern society across a wide range of industries and applications. Processors are the heart of computers, laptops, tablets, and smartphones. They power these devices and enable people to perform various tasks such as browsing the Internet, running applications, processing data, and communicating with others. Processors have revolutionized the way people work, communicate, and access information. Additionally, processors are fundamental to the growth of the Internet of Things (IoT). They are embedded in smart devices, sensors, and appliances, enabling connectivity and data processing. Processors enable IoT devices to collect, analyze, and transmit data, enabling automation, remote monitoring, and control of various systems including smart homes, industrial automation, healthcare devices, and more. Furthermore, processors are key components in communication and networking technologies. They are found in routers, switches, and modems, facilitating data transmission and network management. Processors are also used in telecommunications infrastructure, mobile network equipment, and wireless devices, enabling seamless connectivity and communication.

Processors are present in a wide array of consumer electronics beyond computers and smartphones. They are found in televisions, gaming consoles, digital cameras, home appliances, audio systems, wearables, and more. These processors enable advanced features, user interfaces, and connectivity options in these consumer devices. Processors are pervasive in modern society, shaping how people communicate, work, travel, entertain themselves, and access information. Their versatility, scalability, and computational power have transformed various industries, and continue to drive innovation and advance technology in numerous domains.

Main categories of processors include Complex Instruction Set Computer (CISC) types and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool which in turn creates the gate-level abstraction of the design that is used for downstream implementation operations.

### SUMMARY

Caches play a crucial role in improving processor performance by reducing the latency and bandwidth limitations associated with accessing data from main memory. The cache acts as a temporary storage that holds copies of data that are likely to be used in the near future. When the processor needs to access data, it first checks the cache, and if the data is found, it can be retrieved much more quickly. Caches are designed to store frequently accessed data closer to the processor, enabling faster access times compared to accessing data from main memory. Additionally, caches help optimize the utilization of available memory bandwidth. Main memory has limited bandwidth, and accessing it for every data request can quickly saturate the memory bus. Caches act as a buffer between the processor and memory, absorbing frequent data requests and reducing the overall memory traffic. By storing frequently accessed data in the cache, the processor can avoid unnecessary memory accesses and make more efficient use of the available memory bandwidth. Overall, caches improve processor performance by providing faster access times, reducing memory latency, optimizing memory bandwidth utilization, exploiting locality of reference, and potentially lowering power consumption. They are an essential component of modern processors, enabling efficient data handling and enhancing overall system responsiveness.

Disclosed embodiments provide techniques for direct cache transfer with shared cache. A system on a chip (SOC) is accessed. The SOC includes a plurality of coherent request nodes and a home node. The home node includes a directory-based snoop filter (DSF). A request node requests ownership of a coherent cache line within the SOC. The requesting includes an address associated with the coherent cache line. The home node detects that the coherent cache line is shared with one or more other request nodes. The home node determines a current owner of the coherent cache line. The home node sends an invalidating snoop instruction to the one or more other request nodes and transmits a forwarding snoop instruction. The forwarding snoop instruction establishes a direct cache transfer between the request node and the current owner of the coherent cache line.

A processor-implemented method for cache management is disclosed comprising: accessing a system on a chip (SOC) wherein the SOC communicates internally on a coherent bus, wherein the SOC includes a plurality of coherent request nodes and a first coherent home node, and the first coherent home node includes a directory-based snoop filter (DSF), wherein the DSF comprises a cache with a plurality of ways; requesting, by a first coherent request node within the plurality of coherent request nodes, ownership of a coherent cache line within the SOC, wherein the requesting includes an address associated with the coherent cache line; detecting, by the first coherent home node, that the coherent cache line is shared with one or more other coherent request nodes, wherein the detecting is based on a presence vector within the DSF of the first coherent home node; determining, by the first coherent home node, a current owner of the coherent cache line, wherein the determining is based on information within the DSF of the first coherent home node; sending, by the first coherent home node, to the one or more other coherent request nodes, except the current owner that was determined, an invalidating snoop instruction; and transmitting, by the first coherent home node, a forwarding snoop instruction, wherein the forwarding snoop instruction establishes a direct cache transfer (DCT) between the first coherent request node and the current owner of the coherent cache line.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a direct cache transfer with shared cache lines.

FIG. 2 is a flow diagram for determining a current owner in a direct cache transfer with shared cache lines.

FIG. 3 is a block diagram illustrating a multicore processor.

FIG. 4 is a block diagram for a pipeline.

FIG. 5 is a system block diagram showing a compute coherency block (CCB).

FIG. 6 is a block diagram for coherent transactions in an SOC.

FIG. 7 is a block diagram for a directory-based snoop filter.

FIG. 8 is a system diagram for direct cache transfer with shared cache lines.

### DETAILED DESCRIPTION

Processors are ubiquitous, and are now found in everything from appliances to satellites. Many processors today are multicore processors. Multicore processors provide higher overall processing power by allowing multiple tasks or threads to run simultaneously on different cores. This parallelism enables the system to execute more instructions per unit of time, leading to faster and more efficient processing. Applications that are designed to take advantage of multiple cores can experience significant performance gains. Furthermore, with multiple cores, a multicore processor can handle multiple tasks concurrently. This enables better multitasking capabilities, allowing users to run multiple applications simultaneously without significant performance degradation. Each core can be assigned to different tasks, enhancing the responsiveness and smoothness of multitasking operations. Additionally, multicore processors can provide better power efficiency compared to running multiple single-core processors in a system. By consolidating multiple cores onto a single chip, multicore processors can achieve higher performance per watt. Additionally, individual cores can be powered down or can run at lower frequencies when not fully utilized, reducing overall power consumption. Multicore processors have become increasingly prevalent in modern computing systems due to their ability to deliver improved performance, multitasking capabilities, efficient resource utilization, and power efficiency. They provide a scalable and cost-effective solution for meeting the demands of complex computational tasks and enabling efficient utilization of system resources.

Multicore processors utilize various components to enhance operation. These can include floating point units, interrupt processing modules, memory management modules, and so on. Memory management modules can control operation of memory access, as well as caching. Multicore processors of disclosed embodiments can have multiple levels of cache. In one or more embodiments, a level 1 (L1) cache located within each core of a multicore processor, and a level 2 (L2) cache are shared among multiple cores within the multicore processor. Embodiments can include multiple levels of cache.

Caches play a crucial role in improving processor performance by reducing the latency and bandwidth limitations associated with accessing data from main memory. The cache acts as a temporary storage that holds copies of data that are likely to be used in the near future. When the processor needs to access data, it first checks the cache, and, if the data is found, it can be retrieved much more quickly. Caches are designed to store frequently accessed data closer to the processor, enabling faster access times compared to accessing data from main memory. Additionally, caches help optimize the utilization of available memory bandwidth. Main memory has limited bandwidth, and accessing it for every data request can quickly saturate the memory bus. Caches act as a buffer between the processor and memory, absorbing frequent data requests and reducing the overall memory traffic. By storing frequently accessed data in the cache, the processor can avoid unnecessary memory accesses and can make more efficient use of the available memory bandwidth. Overall, caches improve processor performance by providing faster access times, reducing memory latency, optimizing memory bandwidth utilization, exploiting locality of reference, and potentially lowering power consumption. They are an essential component of modern processors, enabling efficient data handling and enhancing overall system responsiveness.

While caches provide the aforementioned performance benefits, they also can add complexity to a processor. The data within the caches and main memory needs to be consistent in order for the processor to perform properly. This is referred to as cache coherency. Cache coherency refers to the consistency of data stored in different caches that are part of a multiprocessor or multi-core system. In a system with multiple processors or cores, each processor typically has its own cache to reduce memory access latency. However, when multiple caches store copies of the same data, this introduces the possibility of inconsistencies or conflicts when one processor modifies the data and another processor accesses it. In a multicore processor, these issues can be even more challenging when managing memory accesses of multiple individual cores within a multicore processor.

Communication among individual cores of a multicore processor is an important component of implementing programs and applications that can take advantage of the parallelism that such processors provide. Various cores within a multicore processor can be assigned to handle individual tasks, and/or multiple cores can work together on the same task, dividing work as needed. For both of the aforementioned scenarios, a core is often required to take ownership of a cache or a portion of a cache, to read, write, and/or modify the contents of the cache. While caches can improve performance, they can also add overhead for setup, management, and coherency. The coherency can include read coherency. As an example, if one core of a multicore processor reads a shared data item that is already present in its cache, other cores attempting to read the same data should also receive the most up-to-date copy of the data. This ensures that all processors observe a consistent view of the shared data. Similarly, the coherency can include write coherency. In this situation, if one core of a multicore processor modifies a shared data item, the updated value needs to be correctly propagated to all other caches that store the data item. This prevents other processors from accessing stale copies of data or making decisions based on outdated information. The overhead for maintaining the coherency can take away from the theoretical performance gains of using cache.

Disclosed embodiments provide techniques for direct cache transfer with shared cache lines, thereby reducing overhead and enabling improved performance in a multicore processor. A cache line is the smallest portion of data that can be mapped into a cache. In one or more embodiments, the cache line size can be 32, 64 or 128 bytes. Other cache line sizes are possible in disclosed embodiments. In one or more embodiments, a processor-implemented method for sharing data is provided. The method includes accessing a system on a chip (SOC), in which the SOC communicates internally on a coherent bus. An individual core within a multicore processor of disclosed embodiments that requests data may be referred to as a coherent request node. The SOC includes a plurality of coherent request nodes and a first coherent home node, and the first coherent home node includes a directory-based snoop filter (DSF), in which the DSF comprises a cache with a plurality of ways. The home node can orchestrate transfer of cache ownership and/or direct cache transfers from one node to another. The method includes requesting, by a first coherent request node within the plurality of coherent request nodes, ownership of a coherent cache line within the SOC, where the requesting includes an address associated with the coherent cache line. The method further includes detecting, by the first coherent home node, that the coherent cache line is shared with one or more other coherent request nodes, where the detecting is based on a presence vector within the DSF of the first coherent home node. The method further includes determining, by the first coherent home node, a current owner of the coherent cache line, wherein the determining is based on information within the DSF of the first coherent home node; sending, by the first coherent home node, to the one or more other coherent request nodes, except the current owner that was determined, an invalidating snoop instruction; and transmitting, by the first coherent home node, a forwarding snoop instruction, wherein the forwarding snoop instruction establishes a direct cache transfer (DCT) between the first coherent request node and the current owner of the coherent cache line. In embodiments, the current owner of the coherent cache line is referred to as a source node.

Disclosed embodiments address the aforementioned issues by providing techniques for direct cache transfer with shared cache lines. The techniques utilize a coherence ordering agent (COA) to facilitate a direct cache transfer (DCT) between a source core and a destination core within a multicore processor. The DCT reduces the amount of overhead to transfer ownership and/or cache contents from the source core to the destination core, thereby enabling improved multicore processor performance.

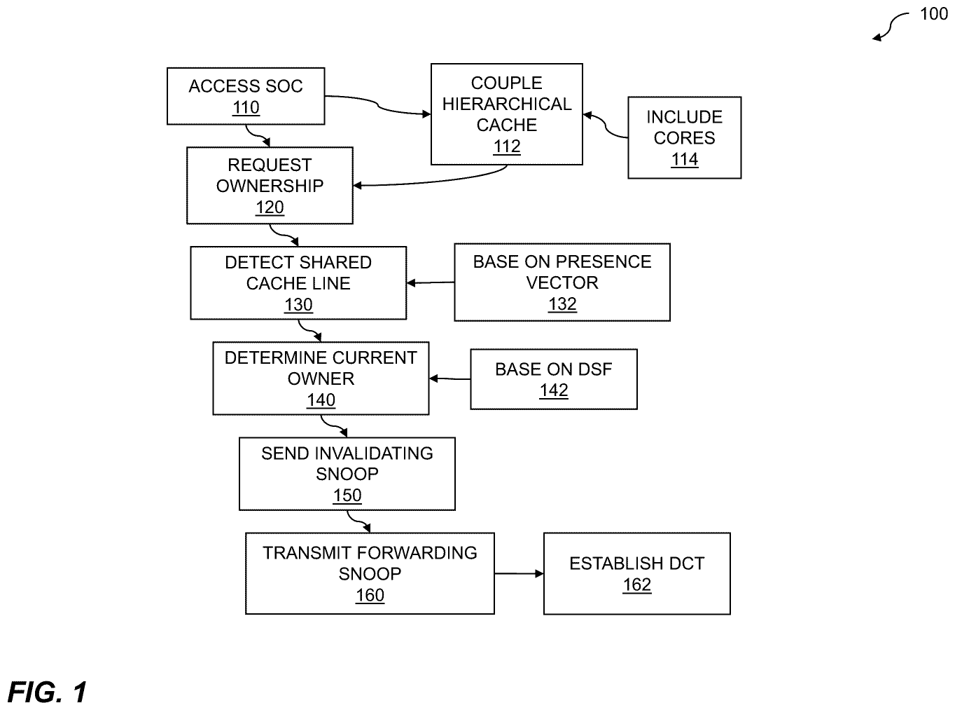

FIG. 1 is a flow diagram for a direct cache transfer with shared cache lines. The flow 100 starts with accessing a System on Chip (SOC) 110. The SOC can include a variety of components. The components can include multiple cores that comprise a multicore processor. The cores can communicate on a shared bus. The SOC can include a multilevel cache system that can include cache local to each core, as well as higher level caches for global usage. The SOC can include other peripherals, such as a digital signal processor (DSP). The DSP can be used to perform signal processing operations such as data collection, data processing, and so on. The SOC can include a graphical processing unit (GPU). The GPU can be used to accelerate operations related to image calculations. SOCs can include other peripherals, such as a Universal Asynchronous Receiver Transmitter (UART), for transmitting transmit and/or receiving serial data. The peripherals included in an SOC depend on their intended applications. Some SOCs can further include encoders and/or decoders for audio and video, modulators and/or demodulators for signals such as Wi-Fi signals and GPS signals, and so on. Regardless of the application, efficient communication between cores of a multicore SOC is an important factor for performance of the SOC.

The flow includes coupling a hierarchical cache 112. In embodiments, the hierarchical cache can include multiple levels of cache, such as level 1, level 2, and level 3. The level 1 (L1) cache may have a faster access time than level 2 (L2) cache, which in turn has a faster access time than level 3 (L3) cache. In the hierarchical cache, lower levels of cache are accessed first, and if a cache miss occurs, the higher-level caches are subsequently accessed. In this way, disclosed embodiments reduce average memory access times by taking advantage of “locality of reference” principles. Disclosed embodiments can include coupling, within the first coherent request node, a hierarchical cache to one or more processor cores within the plurality of processor cores, wherein the hierarchical cache is shared among the one or more processor cores, and wherein the hierarchical cache is further coupled to a compute coherency block (CCB). The flow comprises including cores 114. In one or more embodiments, the number of cores can range between 2-24 cores, but more cores are possible in embodiments. In one or more embodiments, the cores can support multithreading operations. The multithreading operations can enable processes that have two or more instruction threads that may share some resources but execute independently. This can serve to enhance responsiveness, throughput, and/or speed of the process.

The flow includes requesting ownership 120. The requesting can originate from a core of a multicore processor (SOC). The ownership can enable write access to the cache. The cache can be in use by multiple other cores at the time of the requesting. In disclosed embodiments, the requesting initiates coordination and/or arbitration that enables transferring of ownership and/or contents of a cache while maintaining cache coherency for proper operation of programs and applications. Thus, in embodiments, the requesting is accomplished by the CCB within the first coherent request node.

The flow includes detecting a shared cache line 130. The shared cache line can be shared by one or more cores. In one or more embodiments, the detecting is based on a presence vector 132. In one or more embodiments, the presence vector can include a field of bits. The field of bits can include a bit per cache per core that is in the SOC. As an example, with 8 cache lines per core, and 24 cores, the number of bits in the presence vector is 8×24=192 bits. Other sizes for the presence vector are possible in disclosed embodiments, such as 64 bits, 128 bits, and so on. In embodiments, each bit represents a cache line, and a bit that is set in the presence vector indicates that the corresponding core has the cache line associated with the bit.

The flow includes determining the current owner 140. In one or more embodiments, the current owner is determined based on a directory-based snoop filter (DSF) 142. In one or more embodiments, the DSF is an M-way associative set of tables that includes an index number, a valid bit, a presence vector, an owner ID field, and an owner valid field. In one or more embodiments, determining the owner can include obtaining a value in an owner ID field, and checking the validity in a corresponding owner valid field. The flow continues with sending an invalidating snoop command 150. The invalidating snoop command signals to cores that the cache ownership may be changing. In response to receiving the invalidating snoop command, the cores write any information in the “dirty” state, and discontinue use of the cache (or locations within the cache) that are invalidated. In the context of cache memory, a dirty cache entry refers to a cache line or block that has been modified or written by a processor, but has not yet been updated in the main memory. When a processor writes to a cache line, the corresponding entry in the cache becomes “dirty” because it contains data that is different from the corresponding data in the main memory. Dirty cache entries can occur due to the write-back policies used in some cache coherency protocols. In some embodiments, the write-back policy is such that modifications made by a processor are first stored in the cache, and the updated data is only written back to the main memory when the cache line needs to be replaced or when a cache coherency operation requires it.

In disclosed embodiments, cache lines can be in one of a variety of states, reflecting a clean or dirty status, and/or validity. One of the states can be an invalid state, indicating that the cache line is not present in a cache. Another state can include a unique clean (UC) state. In the UC state, the cache line is present only in a single cache. Another state can include a unique clean empty (UCE) state. In the UCE state, the cache line is present only in a single cache, but none of the data bytes are valid. Another state can include a unique dirty (UD) state. In the UD state, the cache line is present only in a single cache, and the cache line has been modified with respect to memory. Another state can include a unique dirty partial (UDP) state. In the UDP state, the cache line is present only in a single cache, and may include some valid data bytes. Another state can include a shared clean (SC) state. In the SC state, other caches may have a shared copy of the cache line, and the cache line might have been modified with respect to memory. Another state can include a shared dirty (SD) state. In the SD state, other caches may have a shared copy of the cache line, and the cache line has been modified with respect to memory.

The flow continues with transmitting a forwarding snoop 160. The forwarding snoop is sent to a source core by a coherence ordering agent (COA) and contains an indicator of a destination core. The source core then establishes a direct cache transfer (DCT) 162 from the source core to the specified destination core. This enables the transfer of data from the source core to the destination core, without any intervention from other cores or coherence ordering agents, thereby improving multicore processor performance. The ownership of the cache can be transferred to the destination node before or after the transferring of the data. In one or more embodiments, transferring the cache ownership comprises adding an entry in the directory-based snoop filter (DSF), and/or modifying an existing entry in the directory-based snoop filter (DSF). The modifying can include clearing (invalidating) the owner valid bit corresponding to the source core. Once the ownership transfer completes, the destination core can perform ownership operations, which can include write operations to the cache. Thus, in embodiments, the forwarding snoop instruction establishes a DCT between the CCB within the first coherent request node and the current owner of the coherent cache line. Additionally, in embodiments, sending an invalidating snoop instruction occurs prior to the transmitting a forwarding snoop instruction. In one or more embodiments, a requesting node can request an empty cache line prior to starting a write operation, enabling saving of system bandwidth by avoiding the need to transfer data that will be overwritten with the subsequent write operation.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

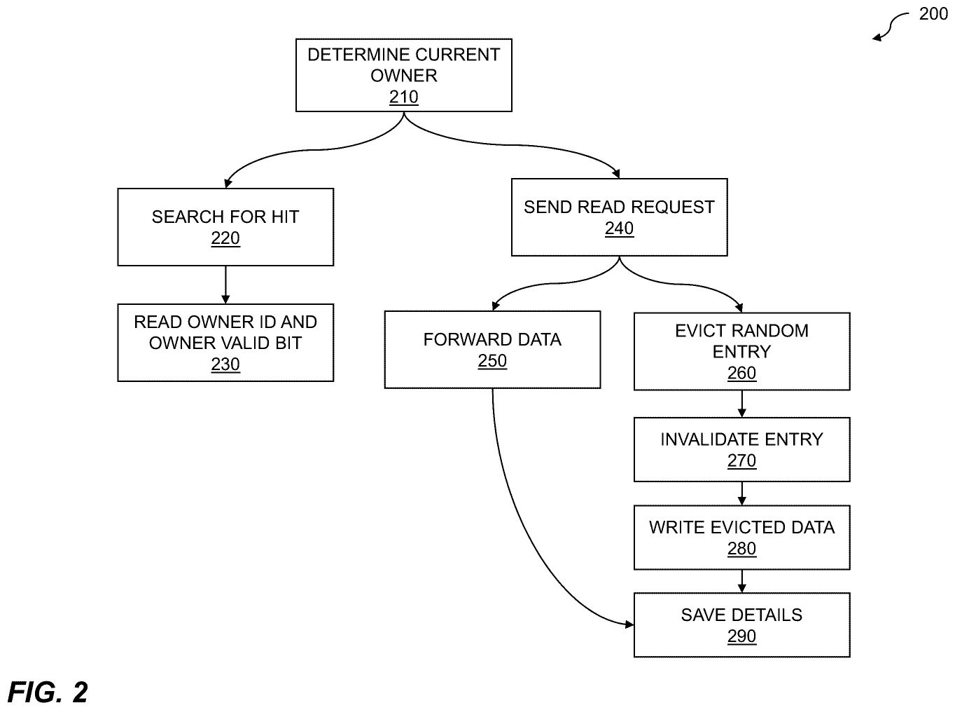

FIG. 2 is a flow diagram for determining a current owner in a direct cache transfer with shared cache lines. The flow 200 includes determining the current owner 210. In one or more embodiments, the current owner is determined based on a directory-based snoop filter (DSF). In one or more embodiments, the DSF is an M-way associative set of tables that includes an index number, a valid bit, a presence vector, an owner ID field, and an owner valid field. In one or more embodiments, determining the owner can include obtaining a value in an owner ID field, and checking the validity in a corresponding owner valid field. The flow can include searching within the DSF for a hit 220. This can include searching, by the first coherent home node, for a hit within the DSF on the address associated with the coherent cache line. If a hit is encountered, the flow can further include reading an owner ID and owner valid bit 230. Thus, embodiments can include reading an owner ID and an owner valid bit within the DSF. In cases where an index of the address associated with the coherent cache line misses in the DSF, the flow includes sending a read request 240 to a memory. Thus, embodiments can include sending a read request to a memory. The flow can further include forwarding data 250 from memory to a coherent request node. The data may be stored in a cache on the SOC, such as an L2 cache, and/or an L1 cache of a coherent request node.

In one or more embodiments, the set associativity of the DSF can be different than the set associativity of the caches. In one or more embodiments, this can occur due to a reduced silicon footprint, for power savings, portable computing applications, cost reduction, and/or other reasons. While the aforementioned features are advantageous, they can cause a scenario in which a coherent request node requests data that results in a DSF miss, where there are no available entries in the DSF. To solve this problem, disclosed embodiments utilize an eviction strategy for freeing entries in the DSF. The flow can include evicting a random entry 260. Disclosed embodiments can include evicting a random entry within the way of the DSF that is associated with the index. In these embodiments, a random entry from within the DSF is discarded to make room for a new entry in the DSF corresponding to the read request. In other embodiments, a different eviction policy can be used. Embodiments can include a temporal eviction policy. The temporal eviction policy can include a least-recently-used (LRU) policy. Embodiments can include a spatial eviction policy. In embodiments, the spatial eviction policy includes evicting an entry in the DSF that corresponds to a core that is farthest away from the core that issued the read request. In one or more embodiments, the distances are based on a priori information such as a core address or index. In embodiments, the index of the address associated with the coherent cache line misses in the DSF, but all ways associated with the index are occupied. Disclosed embodiments address this issue with the aforementioned eviction policies. The flow continues with invalidating the entry 270. Thus, embodiments can include invalidating, by each coherent request node in the plurality of coherent request nodes, an entry corresponding to the random entry within the way of the DSF that was evicted. The flow then continues with writing the evicted data 280. Thus, embodiments can include writing, to a memory, data from the entry that was evicted, wherein the data was marked as dirty in a coherent request node in the plurality of coherent request nodes. The flow further includes saving details 290. Thus, embodiments can include saving, in the DSF, details about the coherent cache line. These details can include, but are not limited to, a presence vector, an owner ID, an owner valid field, an index value, and/or a valid field value.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

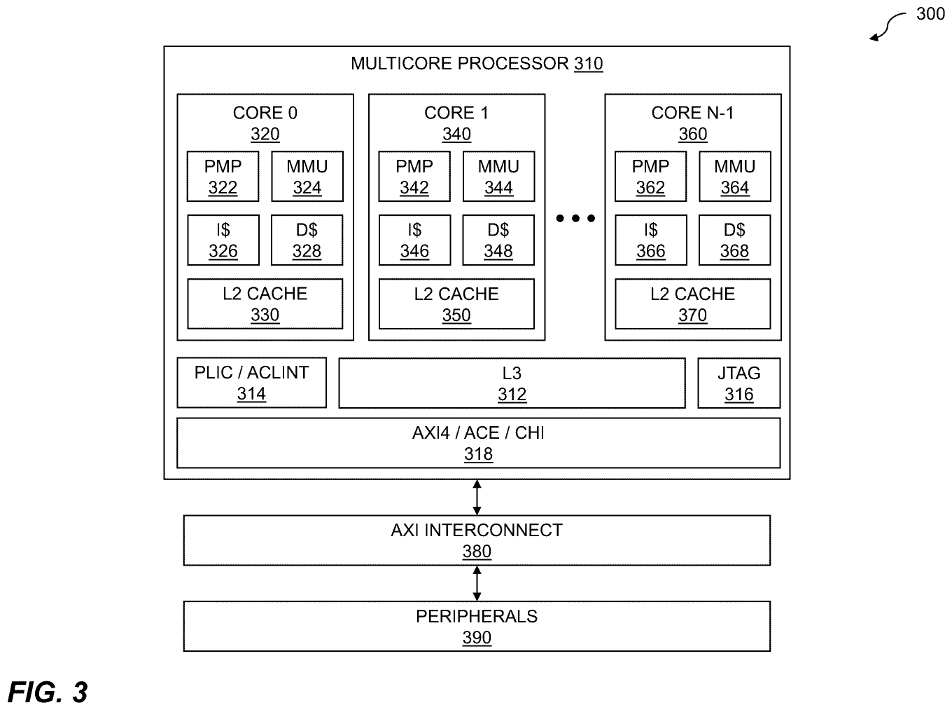

FIG. 3 is a block diagram illustrating a multicore processor. The processor, such as a RISC-V™ processor, ARM processor, or other suitable processor type, can include a variety of elements. The elements can include processor cores, one or more caches, memory protection and management units, local storage, and so on. The elements of the multicore processor can further include one or more of a private cache, a test interface such as a joint test action group (JTAG) test interface, one or more interfaces to a network such as a network-on-chip, shared memory, peripherals, and the like. The multicore processor is enabled by coherency management using distributed snoop. Snoop requests are ordered in a two-dimensional matrix, wherein the two-dimensional matrix is extensible along each axis of the two-dimensional matrix. Snoop responses are mapped to a first-in first-out (FIFO) mapping queue, wherein each snoop response corresponds to a snoop request, and wherein each processor core of the plurality of processor cores is coupled to at least one FIFO mapping queue. A memory access operation is completed, based on a comparison of the snoop requests and the snoop responses.

In the block diagram 300, the multicore processor 310 can comprise two or more processors, where the two or more processors can include homogeneous processors, heterogeneous processors, etc. In the block diagram 300, the multicore processor can include N processor cores such as core 0 320, core 1 340, core N−1 360, and so on. Each processor can comprise one or more elements. In embodiments, each core, including cores 0 through core N−1 can include a physical memory protection (PMP) element, such as PMP 322 for core 0; PMP 342 for core 1, and PMP 362 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N−1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N−1. In addition to the level 1 instruction and data caches, each core can include a level 2 (L2) cache. The level 2 caches can include L2 cache 330 associated with core 0; L2 cache 350 associated with core 1; and L2 cache 370 associated with core N−1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces including an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

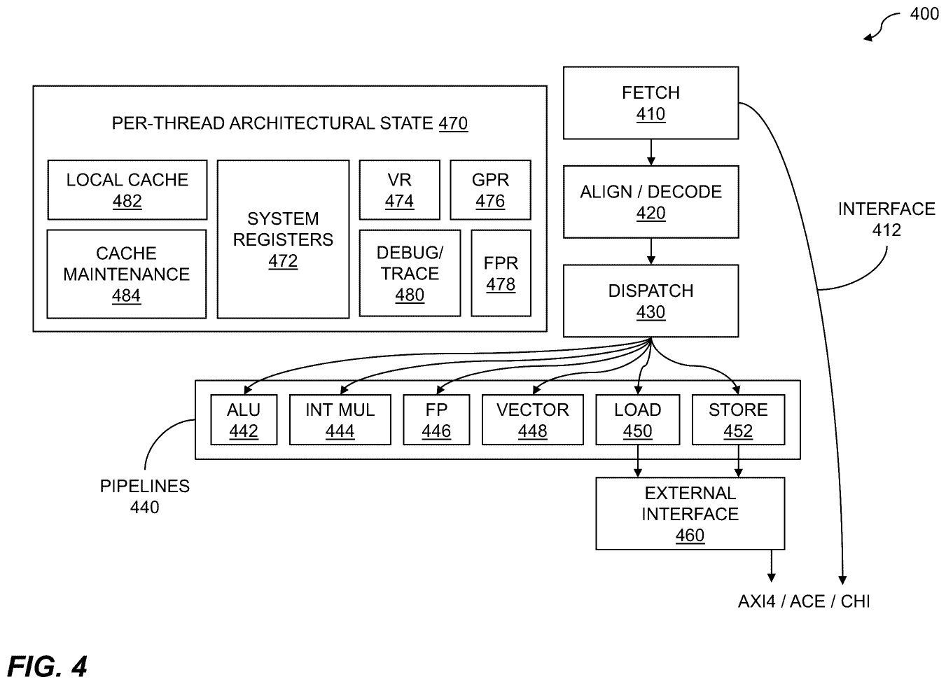

FIG. 4 is a block diagram for a pipeline. The use of one or more pipelines associated with a processor architecture can greatly enhance processing throughput. The processor architecture can be associated with one or more processor cores. The processing throughput can be increased because multiple operations can be executed in parallel. The use of one or more pipelines supports direct cache transfer with shared cache lines. A plurality of processor cores is accessed, wherein the plurality of processor cores comprises a coherency domain, and wherein two or more processor cores within the plurality of processor cores generate read operations for a shared memory structure coupled to the plurality of processor cores.

The block diagram 400 shows a block diagram of a pipeline such as a processor core pipeline. The blocks within the block diagram can be configurable in order to provide varying processing levels. The varying processing levels can be based on processing speed, bit lengths, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The block diagram 400 can include a dispatch block 430. The dispatch block can receive decoded instruction packets from the align and decode block. The decode instruction packets can be used to control a pipeline 440, where the pipeline can include an in-order pipeline, an out-of-order (OoO) pipeline, etc. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipes that can include load pipelines 450, and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474, general purpose registers (GPR) 476, and floating-point registers 478. These registers can be used for vector operations, general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

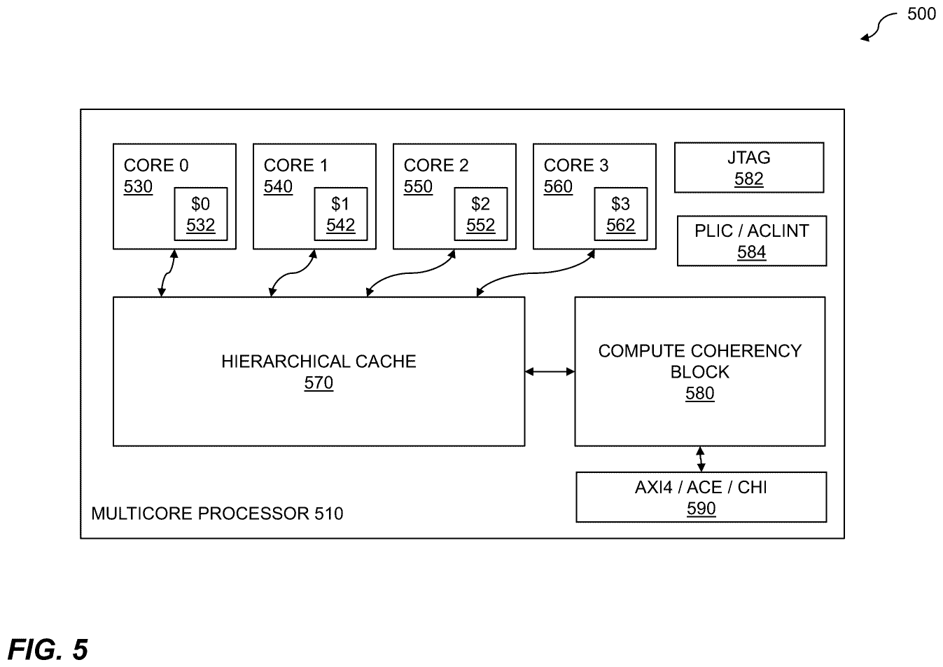

FIG. 5 is a system block diagram showing a multicore processor that includes a compute coherency block (CCB). In the system block diagram 500, multicore processor 510 includes core 0 530, core 1 540, core 2 550, and core 3 560. While four cores are shown in system block diagram 500, in practice, there can be more or fewer cores. As an example, disclosed embodiments can include 16, 32, or 64 cores. Each core comprises an onboard local cache, which is referred to as a level 1 (L1) cache. Core 0 530 includes local cache 532, core 1 540 includes local cache 542, core 2 550 includes local cache 552, and core 3 560 includes local cache 562.

The multicore processor 510 can further include a joint test action group (JTAG) element 582. The JTAG element 582 can be used to support diagnostics and debugging of programs and/or applications executing on the multicore processor 510 by providing access to the processor's internal registers, memory, and other resources. In embodiments, the JTAG element 582 enables functionality for step-by-step execution, setting breakpoints, examining the processor's state during program execution, and/or other relevant functions. The multicore processor 510 can further include a PLIC/ACLINT element 584. As stated previously, the PLIC (a platform level interrupt controller), and/or ACLINT (advanced core local interrupter) support features including, but not limited to, interrupt processing and timer functionalities. The multicore processor 510 can further include a hierarchical cache 570. The hierarchical cache 570 can be a level 2 (L2) cache that is shared among multiple cores within multicore processor 510. In one or more embodiments, the hierarchical cache 570 is a last level cache (LLC). The multicore processor 510 can further include one or more interface elements 590, which can include standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), as previously described.

Multicore processor 510 further includes a compute coherency block (CCB) 580. In one or more embodiments, the compute coherency block (CCB) 580 is responsible for maintaining coherency between one or more caches such as local caches associated with the processor cores and the shared memory system. In embodiments, the CCB 580 interfaces to the hierarchical cache 570, and the interface elements 590. The compute coherency block can perform one or more cache maintenance operations, such as resolving data inconsistencies due to “dirty” data in one or more caches. The dirty data can result from changes to the local copies of shared memory contents in the local caches. The changes to the local copies of data can result from processing operations performed by the processor cores as the cores execute code. Similarly, data in the shared memory can be different from the data in a local cache due to an operation such as a write operation.

In the system block diagram 500, the compute coherency block (CCB) 580 can interface with a DSF. In embodiments, the snoop requests can be based on physical addresses for the shared memory structure. The CCB 580 can perform the functions associated with transferring cache ownership, and/or initiating direct cache transfers (DCTs) in accordance with disclosed embodiments. The physical addresses can include absolute, relative, offset, etc. addresses in the shared memory structure. In embodiments, the DSF can include a two-dimensional matrix, in which each column of the two-dimensional matrix can be headed by a unique physical address corresponding to a particular snoop request. The physical address can correspond to one or more read operations generated by one or more processors within the plurality of processor cores. In embodiments, an additional physical address can initialize an additional column to the two-dimensional matrix when the physical address is unique. The additional physical address can include a unique physical address within a cluster of addresses to be accessed by the plurality of processors. In other embodiments, an additional physical address can add an additional row to the two-dimensional matrix when the physical address is non-unique. The adding the row indicates that an additional read operation has been generated by a processor core. A column within the two-dimensional matrix can comprise a “snoop chain”, where the snoop chain can include a head or first snoop and a tail snoop. In embodiments, the additional row can comprise the tail of a snoop chain for each column of the two-dimensional matrix. In one or more embodiments, the CCB communicates with a home node that includes a DSF to orchestrate direct cache transfers between one or more cores within a plurality of multicore processors within an SOC. In embodiments, the first coherent request node comprises a plurality of processor cores and caches.

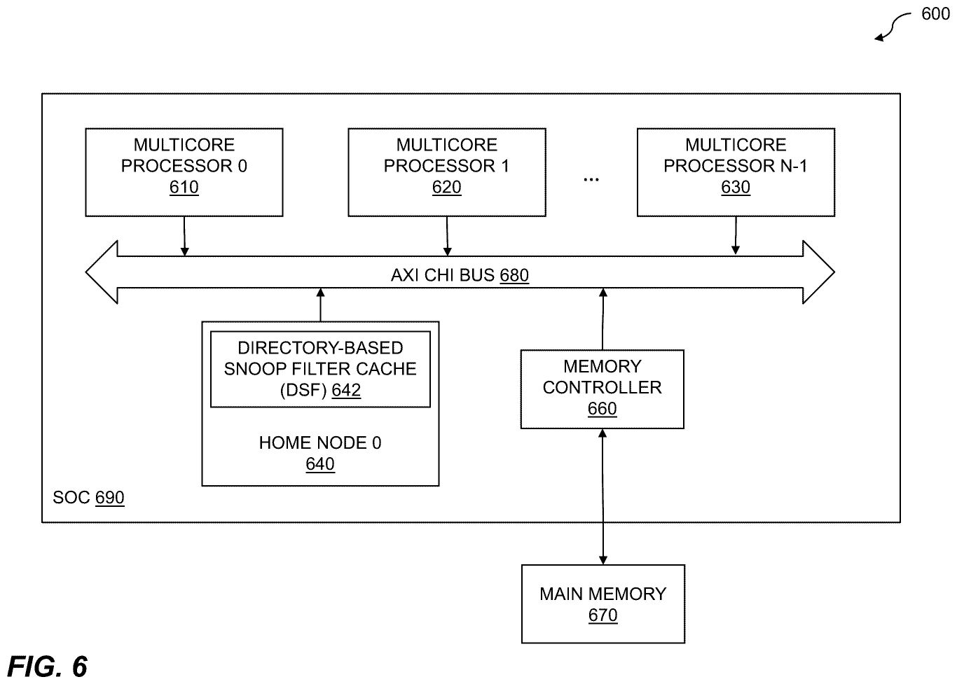

FIG. 6 is a block diagram for coherent transactions in an SOC. In the block diagram 600, SOC 690 can include a plurality of multicore processors. In diagram 600, three multicore processers are shown, indicated as multicore processor 0 610, multicore processor 1 620, and multicore processor N−1 630. In one or more embodiments, the value of N can be in the range of 2-32. Other values of N are possible in disclosed embodiments. Each multicore processor within SOC 690 may be similar to what has been described above. A multicore processor can act as a coherent request node. Within the SOC 690, there can be multiple coherent request nodes. In embodiments, the plurality of coherent request nodes includes one or more multicore processors. In embodiments, a second coherent request node, in the plurality of coherent request nodes, includes a CCB. In embodiments, the DSF includes an entry for each cache line within the hierarchical cache coupled to the CCB of the second coherent request node and the hierarchical cache coupled to the CCB of the second coherent request node. Each multicore processor communicates on bus 680, along with home node 0 640. In embodiments, bus 680 is a coherent bus. In embodiments, the coherent bus supports transactions handled by an interconnect-based home node that coordinates cache and memory accesses by multiple cores of a multicore processor. In embodiments, the coherent bus implements an AMBA CHI coherency protocol. Home node 0 640 may be implemented as a multicore processor similar to that shown in FIG. 5. While SOC 690 shows a single home node, other embodiments may have more than one home node. Thus, in embodiments, the SOC includes a second coherent home node. In some embodiments, the requesting includes the first coherent home node and the second coherent home node. The additional home nodes may be used to increase performance by servicing a subset of the multicore processors within SOC 690, and/or providing redundancy features for improved reliability if a particular home node should fail, in one or more embodiments.

Home node 0 640 contains a DSF 642. The DSF 642 can be implemented as a two-dimensional matrix, in which each column of the two-dimensional matrix can be headed by a unique physical address corresponding to a particular snoop request. The home node 0 640 can interface with the CCB of each multicore processor, and memory controller 660, to enable cache coherency between all caches within the SOC 690, and main memory 670 using a DSF. This enables high performance in a complex SOC that can include billions of transistors. Enabling direct cache transfer (DCT) between two cores within an SOC facilitates features and/or applications that require movements of large amounts of data. These can include, but are not limited to, data encryption and decryption, encoding and decoding of audio and video, machine learning applications, and so on.

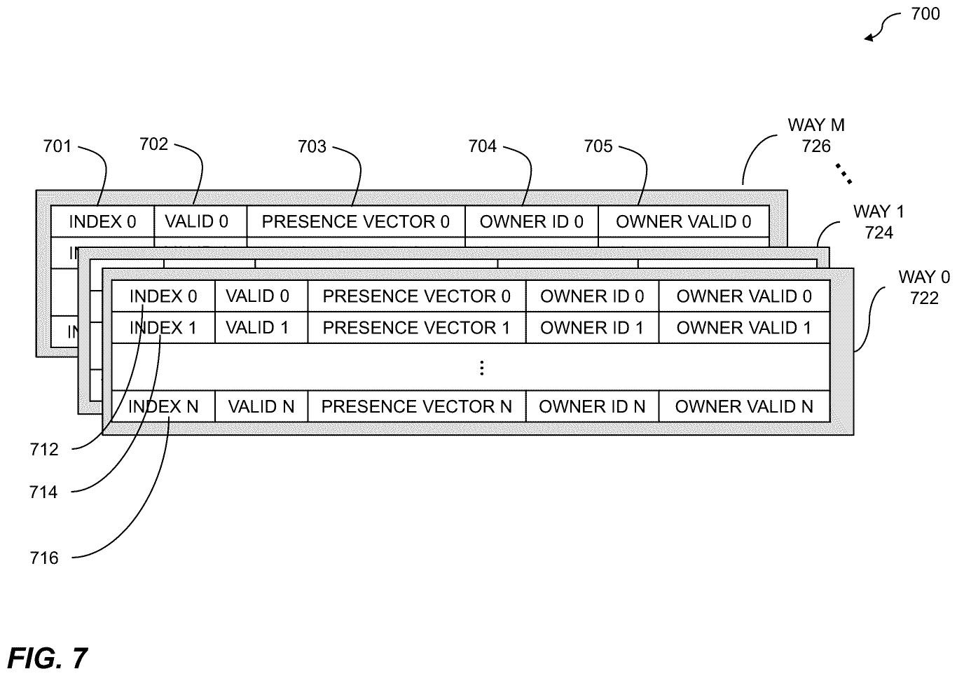

FIG. 7 is a block diagram for a directory-based snoop filter (DSF). The DSF can include an M-way associative table. The block diagram 700 includes way 0 722, way 1 724, and way M 726. In one or more embodiments, the value of M can be in the range from 2-64. Other values of M are possible in disclosed embodiments. Each way includes a plurality of columns. Column 701 includes an index value. The index value provides a mechanism for identifying a given row within the DSF. Column 702 includes a valid indicator for a given row within the DSF. In one or more embodiments, when the valid indicator indicates an invalid entry, the corresponding row is deemed to be available for writing a new entry. Column 703 includes a presence vector. In one or more embodiments, the presence vector can include a field of bits. The field of bits can include a bit per cache per core that is in the SOC as previously stated. Column 704 includes an owner identifier (ID). The owner ID can include a unique number corresponding to a core within a multicore processor and/or SOC. In one or more embodiments, the owner ID can be a bit field of 8 bits, 16 bits, or some other suitable length. Column 705 includes an owner valid bit. The owner valid bit can be an indication of if a given core owns a cache line. Ownership of a cache line can allow certain privileges such as writing to a cache line. For certain operations, such as reading from a cache line, ownership may not be required. Disclosed embodiments may modify the owner ID field, and/or owner valid bit as part of transferring ownership of a cache line from one core to another core. As shown in way 0 722, there are multiple rows, and thus multiple index values, indicated as 712, 714, and 716. In one or more embodiments, to search within the DSF, disclosed embodiments utilize an index value to reference a desired entry in the DSF.

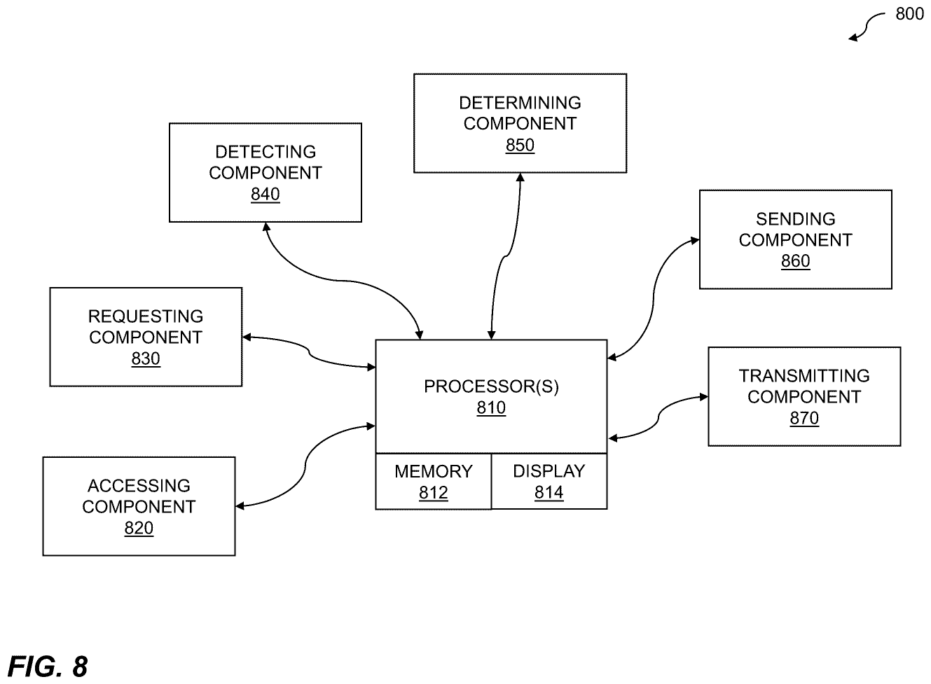

FIG. 8 is a system diagram for direct cache transfer with shared cache lines. The system can include instructions and/or functions for design and implementation of integrated circuits that support direct cache transfer with shared cache lines. The system can include instructions and/or functions for generation and/or manipulation of design data such as hardware description language (HDL) constructs for specifying structure and operation of an integrated circuit. The system can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system 800 can include one or more processors 810. The processors can include standalone processors within integrated circuits or chips, processor cores in FPGAs or ASICs, and so on. The one or more processors 810 are coupled to a memory 812, which stores operations. The memory can include one or more of local memory, cache memory, system memory, etc. The system 800 can further include a display 814 coupled to the one or more processors 810. The display 814 can be used for displaying data, instructions, operations, and the like. The operations can include instructions and functions for implementation of integrated circuits, including processor cores. In embodiments, the processor cores can include RISC-V™ processor cores. In embodiments, one or more processors 810 are coupled to the memory 812, wherein the one or more processors, when executing the instructions which are stored, are configured to: access a system on a chip (SOC) wherein the SOC communicates internally on a coherent bus, wherein the SOC includes a plurality of coherent request nodes and a first coherent home node, and the first coherent home node includes a directory-based snoop filter (DSF), wherein the DSF comprises a cache with a plurality of ways; request, by a first coherent request node within the plurality of coherent request nodes, ownership of a coherent cache line within the SOC, wherein the requesting includes an address associated with the coherent cache line; detect, by the first coherent home node, that the coherent cache line is shared with one or more other coherent request nodes, wherein the detecting is based on a presence vector within the DSF of the first coherent home node; determine, by the first coherent home node, a current owner of the coherent cache line, wherein the determining is based on information within the DSF of the first coherent home node; send, by the first coherent home node, to the one or more other coherent request nodes, except the current owner that was determined, an invalidating snoop instruction; and transmit, by the first coherent home node, a forwarding snoop instruction, wherein the forwarding snoop instruction establishes a direct cache transfer (DCT) between the first coherent request node and the current owner of the coherent cache line.

The system 800 can include an accessing component 820. The accessing component 820 can include functions and instructions for processing design data for implementing an SOC that includes a plurality of multicore processors. The accessing can include accessing a system on a chip (SOC), wherein the SOC communicates internally on a coherent bus, wherein the SOC includes a plurality of coherent request nodes and a first coherent home node, and the first coherent home node includes a directory-based snoop filter (DSF), wherein the DSF comprises a cache with a plurality of ways. The multicore processors can include a local cache hierarchy, prefetch logic, and a prefetch table, where the processor core is coupled to an external memory system. The multicore processors can include FPGAs, ASICS, etc. In embodiments, the multicore processors can include a RISC-V™ processor core, ARM core, or other suitable core type. The multicore processors can include a hierarchical cache that is coupled to a compute coherency block, as previously described.

The system 800 can include a requesting component 830. The requesting component 830 can include functions and instructions for processing design data for requesting, by a first coherent request node within the plurality of coherent request nodes, ownership of a coherent cache line within the SOC, wherein the requesting includes an address associated with the coherent cache line. The requesting can be initiated based on performing operations that necessitate cache ownership.

The system 800 can include a detecting component 840. The detecting component 840 can include functions and instructions for processing design data for detecting, by the first coherent home node, that the coherent cache line is shared with one or more other coherent request nodes, wherein the detecting is based on a presence vector within the DSF of the first coherent home node. When a coherent cache line is shared with one or more other nodes, disclosed embodiments can coordinate transfer of ownership and/or cache data, as well as providing an indication to nodes to write dirty cache entries out to main memory to maintain consistent cache data.

The system 800 can include a determining component 850. The determining component 850 can include functions and instructions for processing design data for determining, by the first coherent home node, a current owner of the coherent cache line, wherein the determining is based on information within the DSF of the first coherent home node. The coherent home node can serve as a coherence ordering agent (COA) which can process a request by a destination core and facilitate a direct cache transfer (DCT) between a source core and the destination core within a multicore processor. In one or more embodiments, a request can have multiple passes in a COA pipe. Different passes can accomplish different stages, such as processing evictions from the DSF or hierarchical cache, loading snoop data/commands, and/or other associated functions.

The system 800 can include a sending component 860. The sending component 860 can include functions and instructions for processing design data for sending, by the first coherent home node, to the one or more other coherent request nodes except the current owner that was determined, an invalidating snoop instruction. The invalidating snoop command signals to cores that the cache ownership may be changing. In response to receiving the invalidating snoop command, the cores write any information in the “dirty” state and discontinue use of the cache (or locations within the cache) that are invalidated.

The system 800 can include a transmitting component 870. The transmitting component 870 can include functions and instructions for processing design data for transmitting, by the first coherent home node, a forwarding snoop instruction, wherein the forwarding snoop instruction establishes a direct cache transfer (DCT) between the first coherent request node and the current owner of the coherent cache line. The forwarding snoop is sent to a source core and contains an indicator of a destination core. The source core then establishes a direct cache transfer (DCT) from the source core to the specified destination core. This enables the transfer of data from the source core to the destination core, without any intervention from other cores or peripherals.

The system 800 can include a computer program product embodied in a non-transitory computer readable medium for cache management, the computer program product comprising code which causes one or more processors to perform operations of: accessing a system on a chip (SOC) wherein the SOC communicates internally on a coherent bus, wherein the SOC includes a plurality of coherent request nodes and a first coherent home node, and the first coherent home node includes a directory-based snoop filter (DSF), wherein the DSF comprises a cache with a plurality of ways; requesting, by a first coherent request node within the plurality of coherent request nodes, ownership of a coherent cache line within the SOC, wherein the requesting includes an address associated with the coherent cache line; detecting, by the first coherent home node, that the coherent cache line is shared with one or more other coherent request nodes, wherein the detecting is based on a presence vector within the DSF of the first coherent home node; determining, by the first coherent home node, a current owner of the coherent cache line, wherein the determining is based on information within the DSF of the first coherent home node; sending, by the first coherent home node, to the one or more other coherent request nodes, except the current owner that was determined, an invalidating snoop instruction; and transmitting, by the first coherent home node, a forwarding snoop instruction, wherein the forwarding snoop instruction establishes a direct cache transfer (DCT) between the first coherent request node and the current owner of the coherent cache line.

As can now be appreciated, disclosed embodiments provide techniques for transferring ownership of a cache, and transferring cache data using a direct cache transfer (DCT). An SOC can include a plurality of multicore processors that communicate via a bus. The SOC can also include a memory controller and one or more home nodes. Each home node also interfaces with the bus. The home node includes a directory base snoop filter (DSF) cache. Each multicore processor within the SOC includes a compute coherency block (CCB) that interfaces with a hierarchical cache and can communicate with other multicore processors within the SOC using the bus. In this way, SOC performance is improved by enabling direct cache transfers, which are a more effective use of compute resources.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for cache management comprising:
accessing a system on a chip (SOC) wherein the SOC communicates internally on a coherent bus, wherein the SOC includes a plurality of coherent request nodes and a first coherent home node, and the first coherent home node includes a directory-based snoop filter (DSF), wherein the DSF comprises a cache with a plurality of ways;
requesting, by a first coherent request node within the plurality of coherent request nodes, ownership of a coherent cache line within the SOC, wherein the requesting includes an address associated with the coherent cache line;
detecting, by the first coherent home node, that the coherent cache line is shared with one or more other coherent request nodes, wherein the detecting is based on a presence vector within the DSF of the first coherent home node;
determining, by the first coherent home node, a current owner of the coherent cache line, wherein the determining is based on information within the DSF of the first coherent home node;
sending, by the first coherent home node, to the one or more other coherent request nodes, except the current owner that was determined, an invalidating snoop instruction; and
transmitting, by the first coherent home node, a forwarding snoop instruction, wherein the forwarding snoop instruction establishes a direct cache transfer (DCT) between the first coherent request node and the current owner of the coherent cache line.

2. The method of claim 1 wherein the first coherent request node comprises a plurality of processor cores and caches.

3. The method of claim 2 further comprising coupling, within the first coherent request node, a hierarchical cache to one or more processor cores within the plurality of processor cores, wherein the hierarchical cache is shared among the one or more processor cores, and wherein the hierarchical cache is further coupled to a compute coherency block (CCB).

4. The method of claim 3 wherein the requesting is accomplished by the CCB within the first coherent request node.

5. The method of claim 4 wherein the forwarding snoop instruction establishes a DCT between the CCB within the first coherent request node and the current owner of the coherent cache line.

6. The method of claim 5 wherein the sending an invalidating snoop instruction occurs prior to the transmitting a forwarding snoop instruction.

7. The method of claim 3 wherein a second coherent request node, in the plurality of coherent request nodes, includes a CCB.

8. The method of claim 7 wherein the DSF includes an entry for each cache line within the hierarchical cache coupled to the CCB of the second coherent request node and the hierarchical cache coupled to the CCB of the second coherent request node.

9. The method of claim 1 wherein the determining further comprises searching, by the first coherent home node, for a hit within the DSF on the address associated with the coherent cache line.

10. The method of claim 9 further comprising reading an owner ID and an owner valid bit within the DSF.

11. The method of claim 1 wherein the determining further comprises sending a read request to a memory.

12. The method of claim 11 wherein an index of the address associated with the coherent cache line misses in the DSF.

13. The method of claim 12 further comprising forwarding data from memory to the first coherent request node.

14. The method of claim 13 further comprising saving, in the DSF, details about the coherent cache line.

15. The method of claim 2 wherein an index of the address associated with the coherent cache line misses in the DSF, but all ways associated with the index are occupied.

16. The method of claim 15 further comprising evicting a random entry within the way of the DSF that is associated with the index.

17. The method of claim 16 further comprising invalidating, by each coherent request node in the plurality of coherent request nodes, an entry corresponding to the random entry within the way of the DSF that was evicted.

18. The method of claim 17 further comprising writing, to a memory, data from the entry that was evicted, wherein the data was marked as dirty in a coherent request node in the plurality of coherent request nodes.

19. The method of claim 18 further comprising saving, in the DSF, details about the coherent cache line.

20. The method of claim 1 wherein the plurality of coherent request nodes includes one or more multicore processors.

21. The method of claim 1 wherein the coherent bus implements an AMBA CHI coherency protocol.

22. The method of claim 1 wherein the SOC includes a second coherent home node.

23. The method of claim 22 wherein the requesting includes the first coherent home node and the second coherent home node.

24. A computer program product embodied in a non-transitory computer readable medium for cache management, the computer program product comprising code which causes one or more processors to perform operations of:
accessing a system on a chip (SOC) wherein the SOC communicates internally on a coherent bus, wherein the SOC includes a plurality of coherent request nodes and a first coherent home node, and the first coherent home node includes a directory-based snoop filter (DSF), wherein the DSF comprises a cache with a plurality of ways;
requesting, by a first coherent request node within the plurality of coherent request nodes, ownership of a coherent cache line within the SOC, wherein the requesting includes an address associated with the coherent cache line;
detecting, by the first coherent home node, that the coherent cache line is shared with one or more other coherent request nodes, wherein the detecting is based on a presence vector within the DSF of the first coherent home node;
determining, by the first coherent home node, a current owner of the coherent cache line, wherein the determining is based on information within the DSF of the first coherent home node;
sending, by the first coherent home node, to the one or more other coherent request nodes, except the current owner that was determined, an invalidating snoop instruction; and
transmitting, by the first coherent home node, a forwarding snoop instruction, wherein the forwarding snoop instruction establishes a direct cache transfer (DCT) between the first coherent request node and the current owner of the coherent cache line.

25. A computer system for cache management comprising:
a memory which stores instructions;
one or more processors coupled to the memory wherein the one or more processors, when executing the instructions which are stored, are configured to:
access a system on a chip (SOC) wherein the SOC communicates internally on a coherent bus, wherein the SOC includes a plurality of coherent request nodes and a first coherent home node, and the first coherent home node includes a directory-based snoop filter (DSF), wherein the DSF comprises a cache with a plurality of ways;
request, by a first coherent request node within the plurality of coherent request nodes, ownership of a coherent cache line within the SOC, wherein the requesting includes an address associated with the coherent cache line;
detect, by the first coherent home node, that the coherent cache line is shared with one or more other coherent request nodes, wherein the detecting is based on a presence vector within the DSF of the first coherent home node;
determine, by the first coherent home node, a current owner of the coherent cache line, wherein the determining is based on information within the DSF of the first coherent home node;
send, by the first coherent home node, to the one or more other coherent request nodes, except the current owner that was determined, an invalidating snoop instruction; and
transmit, by the first coherent home node, a forwarding snoop instruction, wherein the forwarding snoop instruction establishes a direct cache transfer (DCT) between the first coherent request node and the current owner of the coherent cache line.
